(19) United States
(12) Patent Application Publication
(10) Pub. No.: US 2008/0081632 A1
(43) Pub. Date: Apr. 3, 2008

(54) Methods and apparatus for defining, storing, and identifying key performance indicators associated with an RF network

(75) Inventor: Ajay Malik, San Jose, CA (US)

Correspondence Address: INGRASSIA FISHER & LORENZ, P.C., 7150 E. CAMELBACK, STE. 325, SCOTTSDALE, AZ, 85251, US

(73) Assignee: Symbol Technologies, Inc.

(21) Appl. No.: 11/540,093

(22) Filed: Sep. 29, 2006

(51) Int. Cl. H04Q 7/20

(52) U.S. Cl. 455/452.1

(57) ABSTRACT

A system for assessing the state of an RF network includes a plurality of wireless devices coupled to the network and having one or more associated antennae, the wireless devices configured to process data received from a plurality of RF elements within range of the antennae. An RF switch is coupled to the network and configured to receive the data and transmit the data over the network. A first memory within the RF switch is configured to store a system state comprising a plurality of performance indicators, wherein each of the performance indicators is associated with an operational characteristic of one or more of the plurality of wireless devices. A second memory within the RF switch is configured to store a plurality of labeled data entries, the labeled data entries each including the system state and a user-entered identifier, wherein the user-entered identifier includes information related to the time at which the system state was selected. A display coupled to the network is configured to display a comparison of the system states.

### TECHNICAL FIELD

The present invention relates generally to radio frequency identification (RFID) systems, wireless local area networks (WLANs), and other such networks incorporating RF elements, and, more particularly, to methods of storing and identifying the state of an RF network.

### BACKGROUND

Due the size of modern wireless networks, it has become difficult to plan, monitor, manage, and troubleshoot the system as a whole as well as the individual radio frequency (RF) elements. For example, radio frequency identification (RFID) systems have achieved wide popularity in a number of applications, as they provide a cost-effective way to track the location of a large number of assets in real time. In large-scale application such as warehouses, retail spaces, and the like, many RFID tags may exist in the environment. Likewise, multiple RFID readers are typically distributed throughout the space in the form of entryway readers, conveyer-belt readers, mobile readers, etc., and may be linked by network controller switches and the like.

Similarly, there has been a dramatic increase in demand for mobile connectivity solutions utilizing various wireless components and wireless local area networks (WLANs). This generally involves the use of wireless access points that communicate with mobile devices using one or more RF channels (e.g., in accordance with one or more of the IEEE 802.11 standards).

The number of mobile units and associated access ports, as well as the number of RFID readers and associated antennae, can be very large in an enterprise. As the number of components increases, the management and configuration of those components becomes complicated and time-consuming. In particular, it is often difficult to store the state of a system for baselining and for the purpose of referring back to that state to determine, in relative terms, how well it is performing—i.e., whether the load is balanced, whether coverage is suitable, whether there are any intruders, etc. While it is desirable to store historical data constantly, this data can consume a significant amount of memory, and it is thus common to purge old data and keep only recent state data related to the system. As a result, old data that might be useful for the purposes of baselining is typically lost.

Accordingly, it is desirable to provide systems and methods for storing and comparing particular states of an RF network incorporating, for example, RFID and WLAN systems. Furthermore, other desirable features and characteristics of the present invention will become apparent from the subsequent detailed description and the appended claims, taken in conjunction with the accompanying drawings and the foregoing technical field and background.

### BRIEF SUMMARY

A system for assessing the state of an RF network includes: a plurality of wireless devices coupled to the network and having one or more associated antennae, the wireless devices configured to process data received from a plurality of RF elements within range of the antennae; an RF switch coupled to the network and configured to receive the data and transmit the data over the network; a first memory within the RF switch, the first memory configured to store a system state comprising a plurality of performance indicators, wherein each of the performance indicators is associated with an operational characteristic of one or more of the plurality of wireless devices; a second memory within the RF switch, the second memory configured to store a plurality of labeled data entries, the labeled data entries each including the system state and a user-entered identifier, wherein the user-entered identifier includes information related to the time at which the system state was selected; and a display coupled to the network for displaying a comparison of the system states.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a conceptual overview of a system in accordance with an exemplary embodiment of the present invention;

FIG. 2 is a conceptual diagram of a RF switch having a memory and various performance indicators stored therein; and

FIG. 3 is an example graphical comparison of performance indicators.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention.

For the sake of brevity, conventional techniques related to signal processing, data transmission, signaling, network control, the 802.11 family of specifications, wireless networks, RFID systems and specifications, and other functional aspects of the system (and the individual operating components of the system) may not be described in detail herein. Furthermore, the connecting lines shown in the various figures contained herein are intended to represent example functional relationships and/or physical couplings between the various elements. Many alternative or additional functional relationships or physical connections may be present in a practical embodiment.

Without loss of generality, in the illustrated embodiment, many of the functions usually provided by a traditional access point (e.g., network management, wireless configuration, etc.) and/or traditional RFID readers (e.g., data collection, RFID processing, etc.) are concentrated in a corresponding RF switch. It will be appreciated that the present invention is not so limited, and that the methods and systems described herein may be used in conjunction with traditional access points and RFID readers or any other device that communicates via RF channels.

The present invention relates a method of storing certain states of a RF network using a set of key performance indicators (“performance indicators,” or simply KPI). The state of the system is “labeled,” as described below, and only these labeled states are stored within the system. These labeled states can then be used for benchmarking performance of the RF network.

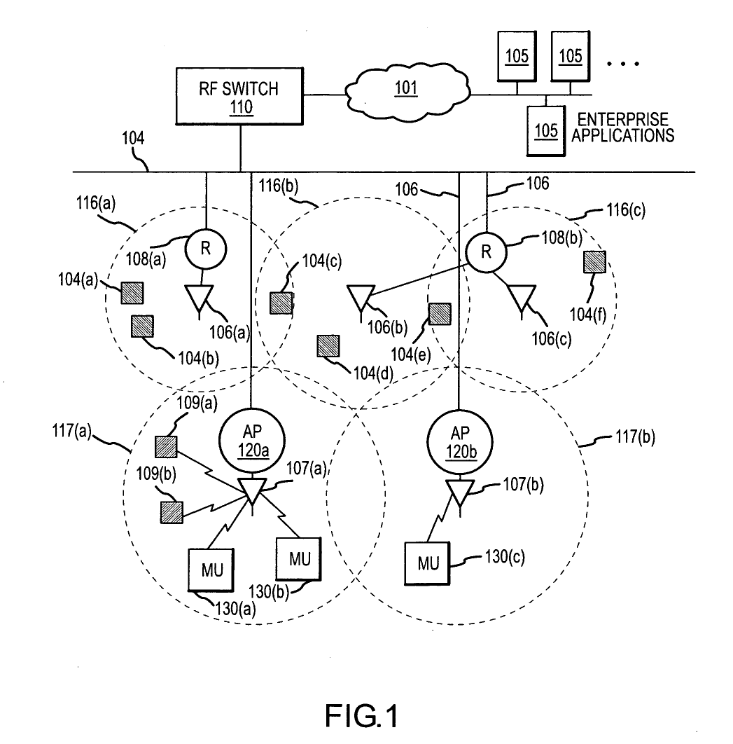

Referring to FIG. 1, in an example system useful in describing the present invention, a switching device 110 (alternatively referred to as an “RF switch,” “WS,” or simply “switch”) is coupled to a network 101 and 104 (e.g., an Ethernet network coupled to one or more other networks or devices) which communicates with one or more enterprise applications 105. One or more wireless access ports 120 (alternatively referred to as “access ports” or “APs”) are configured to wirelessly connect to one or more mobile units 130 (or “MUs”). APs 120 suitably communicate with switch 110 via appropriate communication lines 106 (e.g., conventional Ethernet lines, or the like). Any number of additional and/or intervening switches, routers, servers and other network components may also be present in the system.

A number of RFID tags (or simply “tags”) 104, 107 are distributed throughout the environment. These tags are read by a number of RFID readers (or simply “readers”) 108 having one or more associated antennas 106 provided within the environment. The term “tag” refers, in general, to any RF element that can be communicated with and has an ID that can be read by another component. Readers 108, each of which may be stationary or mobile, are suitably connective via wired or wireless data links to a RF switch 110.

A particular AP 120 may have a number of associated MUs 130. For example, in the illustrated topology, MUs 130(a) and 130(b) are associated with AP 120(a), while MU 130(c) is associated with AP 120(b). One or more APs 120 may be coupled to a single switch 110, as illustrated.

RF Switch 110 determines the destination of packets it receives over network 104 and 101 and routes those packets to the appropriate AP 120 if the destination is an MU 130 with which the AP is associated. Each WS 110 therefore maintains a routing list of MUs 130 and their associated APs 130. These lists are generated using a suitable packet handling process as is known in the art. Thus, each AP 120 acts primarily as a conduit, sending/receiving RF transmissions via MUs 130, and sending/receiving packets via a network protocol with WS 110. AP 120 is typically capable of communicating with one or more MUs 130 through multiple RF channels. This distribution of channels varies greatly by device, as well as country of operation. For example, in one U.S. embodiment (in accordance with 802.11(b)) there are fourteen overlapping, staggered channels, each centered 5 MHz apart in the RF band.

A particular RFID reader 108 may have multiple associated antennas 106. For example, as shown in FIG. 1, reader 108(a) is coupled to one antenna 106(a), and reader 108(b) is coupled to two antennas 106(b) and 106(c). Reader 108 may incorporate additional functionality, such as filtering, cyclic-redundancy checks (CRC), and tag writing, as is known in the art.

In general, RFID tags (sometimes referred to as “transponders”) may be classified as either active, passive, or semi-active. Active tags are devices that incorporate some form of power source (e.g., batteries, capacitors, or the like) and are typically always “on,” while passive tags are tags that are exclusively energized via an RF energy source received from a nearby antenna. Semi-active tags are tags with their own power source, but which are in a standby or inactive mode until they receive a signal from an external RFID reader, whereupon they “wake up” and operate for a time just as though they were active tags. While active tags are more powerful, and exhibit a greater range than passive tags, they also have a shorter lifetime and are significantly more expensive. Such tags are well known in the art, and need not be described in detail herein.

Each antenna 106 has an associated RF range (or “read point”) 116, which depends upon, among other things, the strength of the respective antenna 106. The read point 116 corresponds to the area around the antenna in which a tag 104 may be read by that antenna, and may be defined by a variety of shapes, depending upon the nature of the antenna (i.e., the RF range need not be circular or spherical as illustrated in FIG. 1). An antenna 107 coupled to an AP 120 may also communicate directly with RFID tags (such as tags 109(a) and 109(b), as illustrated).

It is not uncommon for RF ranges or read points to overlap in real-world applications (e.g., doorways, small rooms, etc.). Thus, as shown in FIG. 1, read point 116(a) overlaps with read point 116(b), which itself overlaps with read point 116(c). Accordingly, it is possible for a tag to exist within the range of two or more readers simultaneously. For example, tag 104(c) falls within read points 116(a) and 116(b), and tag 104(f) falls within read points 116(b) and 116(c). Because of this, two readers (108(a) and 108(b)) may sense the presence of (or other event associated with) tag 104(c).

As described in further detail below, switch 102 includes hardware, software, and/or firmware capable of carrying out the functions described herein. Thus, switch 102 may comprise one or more processors accompanied by storage units, displays, input/output devices, an operating system, database management software, networking software, and the like. Such systems are well known in the art, and need not be described in detail. Switch 102 may be configured as a general purpose computer, a network switch, or any other such network host. In a preferred embodiment, controller 102 is modeled on a network switch architecture but includes RF network controller software (or “module”) whose capabilities include, among other things, the ability to allow configure and monitor readers 108 and antennas 106.

RF switch 110 allows multiple read points 116 to be logically combined, via controller 102, within a single read point zone (or simply “zone”). For example, referring to FIG. 1, a read point zone 120 may be defined by the logical union of read points 116(a), 116(b), and 116(c). Note that the read points need not overlap in physical space, and that disjoint read points (e.g., read point 116(d)) may also be included in the read point zone if desired. In a preferred embodiment, antennas (i.e., read points defined by the antennas) can be arbitrarily assigned to zones, regardless of whether they are associated with the same reader. That is, referring to FIG. 1, antennas 106(b) and 106(c), while both associated with reader 108(b), may be part of different zones. Controller 102 then receives all tag data from readers 108 via respective data links 103 (e.g., wired communication links, 802.11 connections, or the like), then aggregates and filters this data based on zone information. The read point zones are suitably preconfigured by a user or administrator. That is, the user is allowed to access controller 110 and, through a configuration mode, specify a set of read points that are to be included in a particular zone. RF switch 110 includes a cell controller (CC) and an RFID network controller (RNC), In general, the RNC includes hardware and software configured to handle RFID data communication and administration of the RFID network components, while the CC includes hardware and software configured to handle wireless data (e.g., in accordance with IEEE 802.11) from the mobile units and access ports within wireless cells. In one embodiment, RF switch 110 includes a single unit with an enclosure containing the various hardware and software components necessary to perform the various functions of the CC and RNC as well as suitable input/output hardware interfaces to networks 101 and 104.

As mentioned above, the present invention relates to a method and system for storing certain states of a RF network using a set of key performance indicators (“performance indicators,” or simply KPI). The state of the system is “labeled,” as described below, and only these labeled states are stored within the system.

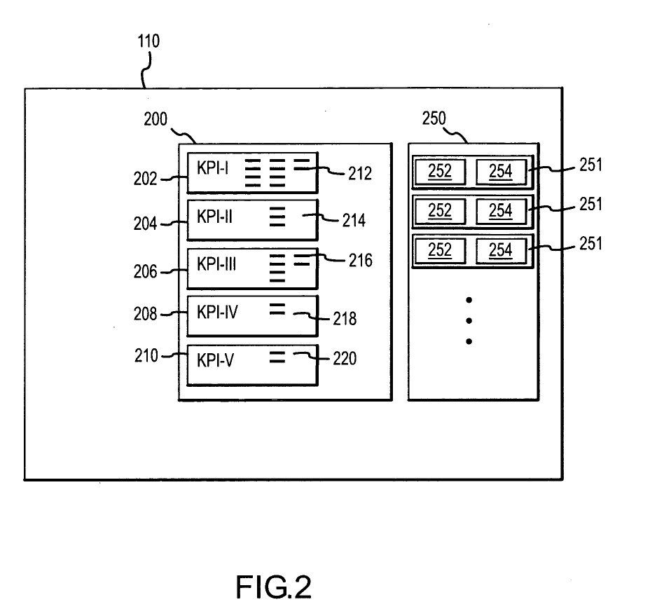

While any number of performance indicators may be used, in a particular embodiment, five performance indicators are defined as a factory default: KPI-I through KPI-V as described below. This is illustrated conceptually in FIG. 2, wherein RF switch is shown with a memory 200 (i.e., any form of conventional storage) used to store five performance indicators 202, 204, 206, 208, and 210. These performance indicators may alternatively be stored elsewhere in the network, or distributed over multiple servers or hosts. RF switch 110 also includes a second memory 250 (which is a different memory logically, but might be the same memory physically) that stores labeled data entries 251, as described further below. Furthermore, the user or administrator is allowed to create and use his own performance indicators. That is, the user is provided with a suitable set of variables and mathematical formulae that can be selected to define customer performance indicators that fit the particular application.

In the illustrated embodiment, the first performance indicator 202 (KPI-I) is a metric associated with RF coverage. In one embodiment KPI-I includes a set of numbers 212 associated with RF coverage in the RF network (KPI-I(a)-(i)). That is, KPI-I is computed from this set of numbers, wherein the numbers relate to measured characteristics of the network or the components disposed therein. In one embodiment, KPI-I(a) is equal to the number of system components that are operational and/or configured—i.e., 802.11 APs, 802.11 radios, RFID readers, RFID antennas, WiMAX APs, and WiMax Radios, and any other components as may be appropriate. KPI-I(b) is equal to the number of system components with operational and/or configured channels. KPI-I(c) is associated with the number of system components with operational and/or configured power. KPI-I(d) is equal to the number of operational and/or configured data rates. KPI-I(e) is equal to the number of MUs transfer at maximum bit speed, number of tags seen, channel health as seen per tag read, etc. KPI-I(f) is equal to the number of switch level retries and collision count per bucket. KPI-I(g) is equal to switch level average 802.11 RSSI per bucket/channel health per tag read. KPI-I(h) is equal to the average bit speed and how close it is to the maximum rate possible for the various MUs. KPI-I(i) is equal to the average 802.11 bit speed/RFID tag read rate/collision rate as per predicted and/or current heat map of the facility in which the components are deployed. It will be appreciated that these specific metrics for KPI-I(a)-(i).

The second performance indicator 204 (KPI-II) is a metric associated with load balancing in the RF network. In a specific embodiment, KPI-II includes a set of three numbers 214, KPI-II(a)-(c), where KPI-II(a) is associated with the balancing of APs across switches, KPI-II(b) is associated with the balancing of MUs across switches, and KPI-II(c) is associated with the number of MUs balanced across APs. This enables the user to add changes in the network to provide better RF coverage as load increases and performance suffers.

The third performance indicator 206 (KPI-III) is a metric associated with security threat level. In a specific embodiment, KPI-III includes a set of six numbers 216, KPI-III(a)-(f), where KPI-III(a) is associated with the number of detected rogue APs and/or RFID readers or RF devices as managed by the RF switch, KPI-III(b) is associated with the number of IDS events (i.e., intrusion detection events such as sniffer attacks, denial-of-service attacks, and the like), KPI-III(c) is associated with the amount of RF slippage currently and/or planned, KPI-III(d) is associated with the location of one or more intruders, KPI-III(e) is associated with the number of users connected to the network, and KPI-III(f) is associated with the number of incorrect password requests. This enables a user to determine whether some action must be taken to secure the network or make operational changes in the network.

The fourth performance indicator 208 (KPI-IV) is a metric associated with redundancy (i.e., a redundancy quotient or “resiliency quotient”). In a specific embodiment, KPI-IV includes a set of two numbers 218: KPI-IV(a), which is associated with the status of members of a particular cluster within the network (e.g., how many are reachable, how many are standbys), and KPI-IV(b), which is associated with the self-healing status of the radios, RFID antennas, WiMax radios, etc. This enables the user to determine whether the network as enough “resiliency” to tolerate failures, and specify the thresholds at which some action must be taken.

The fifth performance indicator 210 (KPI-V) is a metric associated with network utilization. In a specific embodiment, KPI-V includes a set of two numbers 220: KPI-V(a), which is associated with the number of switches and the capacity of the switches under current usage, and KPI-V(b), which is associated with the number of radios, the capacity of the radios, and their current usage.

The values of the performance indicators may be integers, real numbers, or any suitable numeric value. The performance indicators may be normalized (e.g., to a number between 0-100, or 0.0-1.0), or may an unbounded numeric value. Each performance indicator is a suitable function of the set of numbers it comprises. For example, KPI-II comprises three numbers, each related to the number of components that are balanced among other components of the system. In each case, the balancing may be assigned a number ranging from zero (not balanced) and 100 (fully balanced). A weighting function or linear equation may then be applied to each of these three numbers to produce a given numeric value of KPI-II, which itself ranges between 0 and 100. The selection of functions for each of the performance indicators may be selected in accordance with known principles and to achieve any particular design goal.

As shown in FIG. 2, a memory 250 is used to store labeled data entries 251, each of which includes an identifier 252 and data 254. Identifier 252 may include any suitable alphanumeric string of characters useful for the administrator in identifying data 254. Data 254 reflects the state of the system at a particular time, and thus would include at least the performance indicators as described above.

Identifier 252 may be partially automatically generated (by RF switch 110) or entirely manually generated (by the administrator). Identifier 252 might typically include, among other things, detailed date and time information expressed in any convenient format (e.g., HH:MM:SS DD/MM/YYYY) as well as text that assists the administrator in remembering the purpose and/or significance of the data (e.g., “system at peak performance”).

Data 254 preferably includes the various performance indicator values, but might also include raw data (or a subset of raw data) from which those performance indicators are derived. The number of labeled data entries 251 is limited only by the available memory of RF switch 110.

During operation, then, the administrator accesses RF switch 110 and instructs the system to take a “snapshot” of the state of the RF network at that time. The administrator then enters a suitable identifier 252 (which may be all or partially generated automatically). The system stores the identifier 252 along with the appropriate data 254 in a single labeled data entry 251 within memory 250.

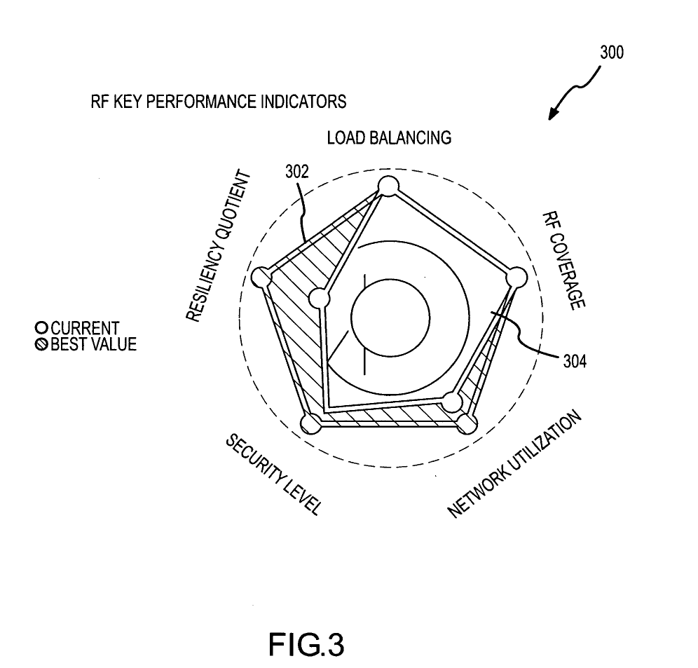

Subsequently, the administrator may access RF switch 110 and retrieve a particular labeled data entry 251. This may be achieved by using a conventional browsing or search function. The retrieved labeled data entry may then be compared to the current state of the system. This comparison may be done by comparing raw numbers side-by-side, or by using any convenient graphical technique (e.g., bar charts, line charts, etc.). FIG. 3 shows an example graphical comparison 300, which depicts a planar, polar coordinate system wherein each of the KPIs are graphed along respective rays leading from the origin. The individual KPI values along those rays are connected to produce a polygon. Thus, for example, a “best value” polygon 302 may be compared visually to the “current” polygon 304.

It should be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A system for assessing the state of an RF network, the system comprising:
a plurality of wireless devices coupled to the network and having one or more associated antennae, the wireless devices configured to process data received from a plurality of RF elements within range of the antennae;
an RF switch coupled to the network and configured to receive the data and transmit the data over the network;
a first memory within the RF switch, the first memory configured to store a system state comprising a plurality of performance indicators, wherein each of the performance indicators is associated with an operational characteristic of one or more of the plurality of wireless devices;
a second memory within the RF switch, the second memory configured to store a plurality of labeled data entries, the labeled data entries each including the system state and a user-entered identifier, wherein the user-entered identifier includes information related to the time at which the system state was selected; and
a display coupled to the network for displaying a comparison of the system states.

2. The system of claim 1, wherein the comparison comprises a bar graph comparison.

3. The system of claim 1, wherein the performance indicators include a performance indicator associated with RF coverage of the network.

4. The system of claim 1, wherein the performance indicators include a performance indicator associated with load balancing of the network.

5. The system of claim 1, wherein the performance indicators include a performance indicator associated with security threat level.

6. The system of claim 1, wherein the performance indicators include a performance indicator associated with a redundancy quotient of the network.

7. The system of claim 1, wherein the performance indicators include a performance indicator associated with network utilization.

8. The system of claim 1, wherein the identifier is at least partially automatically generated.

9. A method for monitoring the state of an RF network, the method comprising:
providing a plurality of wireless devices coupled to the network and having one or more associated antennae, the wireless devices configured to process data received from a plurality of RF elements within range of the antennae;
determining a plurality of performance indicators, wherein each of the performance indicators is associated with an operational characteristic of one or more of the plurality of wireless devices;
allowing a user to select a first state of the network at a first time and to enter a first identifier associated with the first state, wherein the first identifier includes information relating to the first time;
storing a labeled data entry, the labeled data entry including the first identifier and the first state;
retrieving the labeled data entry;
determining a current state of the network at a second time; and
displaying a visual representation of a comparison of the first state to the second state.

10. The method of claim 9, wherein displaying the visual representation comprises displaying a bar graph comparing the first state to the second state.

11. The method of claim 9, wherein the performance indicators include a performance indicator associated with RF coverage of the network.

12. The method of claim 9, wherein the performance indicators include a performance indicator associated with load balancing of the network.

13. The method of claim 9, wherein the performance indicators include a performance indicator associated with security threat level.

14. The method of claim 9, wherein the performance indicators include a performance indicator associated with a redundancy quotient of the network.

15. The method of claim 9, wherein the performance indicators include a performance indicator associated with network utilization.

16. The method of claim 9, further including storing the performance indicators in a memory provided within an RF switch coupled to the plurality of wireless devices over the network.

17. The method of claim 9, further including storing the labeled data entry in a memory provided within an RF switch coupled to the plurality of wireless devices over the network.

18. The method of claim 9, including allowing a user to define the custom performance indicators.
